(19) United States
(12) Patent Application Publication
(10) Pub. No.: US 2023/0142464 A1
(43) Pub. Date: May 11, 2023

(54) MULTIFUNCTIONAL BARBECUE GRILL

(71) Applicant: Xiaowei LI, Xiamen City (CN)

(72) Inventor: Xiaowei LI, Xiamen City (CN)

(21) Appl. No.: 17/519,579

(22) Filed: Nov. 5, 2021

(51) Int. Cl. A47J 37/07; A23B 4/052

(52) U.S. Cl. CPC A47J 37/0786; A47J 37/0763; A23B 4/052

(57) ABSTRACT

A multifunctional barbecue grill, wherein the barbecue grill is provided with two basket bodies, the basket bodies are hinged to each other at the back edges of the opening ends; a plurality of first sleeves coaxially aligned from front to back are provided on the left side of the bottom surface of each basket body, and a plurality of second sleeves coaxially aligned from the front to the back are provided on the right side of the bottom surface of each basket body; the barbecue grill is provided with two rod-shaped handles, one rod-shaped handle penetrates the first sleeve successively in a threaded manner, and the other rod-shaped handle penetrates the second sleeve successively in a threaded manner; and the barbecue grill is provided with two smoker boxes separately made of metal plates, the smoker boxes are respectively placed at the left and right ends inside the basket body.

### BACKGROUND OF THE INVENTION

The present utility model relates to the technical field of cooking devices, and specifically discloses a multifunctional barbecue grill.

Barbequeing is a cooking method for baking food on a fire and cooking it to be edible, and in recent years, it has developed into a leisure and entertainment activity called a multi-person conference. With the development of living standards and technical standards, there are various cooking devices for barbecueing, one of which is a barbecue grill.

A barbecue grill usually has a basket-like structure made of an iron wire mesh, which is mainly used for holding and baking large batches of food at the same time. A rod-shaped handle for a user to hold is provided on one side of the basket body. In order to facilitate the turning over of food during the barbecue process, an open and closed cover body can be configured on the basket body, the food can be properly limited in the basket body by means of the cover body, and the food can be turned over by turning over the barbecue grill by means of a rod-shaped handle.

The applicant found that barbecue grills in the prior art has generated many defects due to the following customary settings:

(1) the rod-shaped handle is fixedly connected to the basket body in a non-detachable manner, so that the rod-shaped handle is prone to scald a user's hand due to an excessively high temperature of the rod-shaped handle during the barbecue process, and the barbecue grill occupies excessive space when being idle, thereby being inconvenient to store and carry;

(2) the basket body and the cover body do not have a reliable open and closed fitting structure, and when the barbecue grill is turned over, it is easy to cause the accident of food scattering due to incorrect closing and unfirm closing of the basket body and the cover body; and

(3) the barbecue grill can only bake food with a single cooking function.

### BRIEF SUMMARY OF THE INVENTION

The present utility model aims at providing a multifunctional barbecue grill aiming at the shortcomings of the prior art, and the technical solution thereof is as follows.

A multifunctional barbecue grill, wherein the barbecue grill is provided with two basket bodies made of iron wire meshes, opening ends of the two basket bodies are relatively fitted to each other at the top and the bottom, and the two basket bodies are hinged to each other at the back edges of the opening ends;

a first lock catch movably connected is provided at the front edge of an opening end of an upper basket body, and a first lock rod for enabling the first lock catch to be detachably connected is provided at the front edge of an opening end of a lower basket body;

a plurality of first sleeves coaxially aligned from the front to the back are provided on the left side of the bottom surface of each basket body, a plurality of second sleeves coaxially aligned from the front to the back are provided on the right side of the bottom surface of each basket body, and the first sleeves and the second sleeves are symmetrically provided with respect to the center line of the bottom surface of each basket body;

the barbecue grill is provided with two rod-shaped handles, one rod-shaped handle penetrates the first sleeve successively in a threaded manner, and the other rod-shaped handle penetrates the second sleeve successively in a threaded manner; an inward recessed clearance groove is provided at the bottom surface of each basket body so as to accommodate the rod-shaped handle handles; and

the barbecue grill is provided with two smoker boxes separately made of metal plates, the smoker boxes are respectively placed at the left and right ends inside the basket body, and the clearance groove at the bottom surface of the basket body abuts against one side of the smoker boxes so as to face towards the middle of the basket body; a whole body of each smoker box is provided with a plurality of small holes, one side of each smoker box is provided as an open end, and a removable cover plate is mounted inside the open end.

Compared with the prior art, the present utility model has the following beneficial effects:

(1) the rod-shaped handle is detachable, and is more convenient to store and carry when being idle; during the barbecue process, when the barbecue grill does not need to be turned over and transferred, the rod-shaped handle can be removed to avoid an excessively high temperature;

(2) the basket bodies have reliable open and closed fitting structures, and when the barbecue grill is turned over, there will not have the accident of food scattering due to incorrect closing and unfirm closing; and

(3) the barbecue grill is provided with the smoker boxes, and has cooking functions of barbecueing and smoking.

The utility model will be further described in conjunction with the accompanying drawings and specific embodiments.

### BRIEF DESCRIPTION OF THE DRAWINGS

FIG. 1 is a structural schematic diagram of the utility model.

FIG. 2 is an exploded view of the assembly structure of the utility model.

FIG. 3 is a structural schematic diagram of a first lock catch in the present utility model.

FIG. 4 is a structure diagram of a second lock catch in the utility model.

FIG. 5 is a structural schematic diagram of a smoker box of the present utility model.

### DETAILED DESCRIPTION OF THE INVENTION

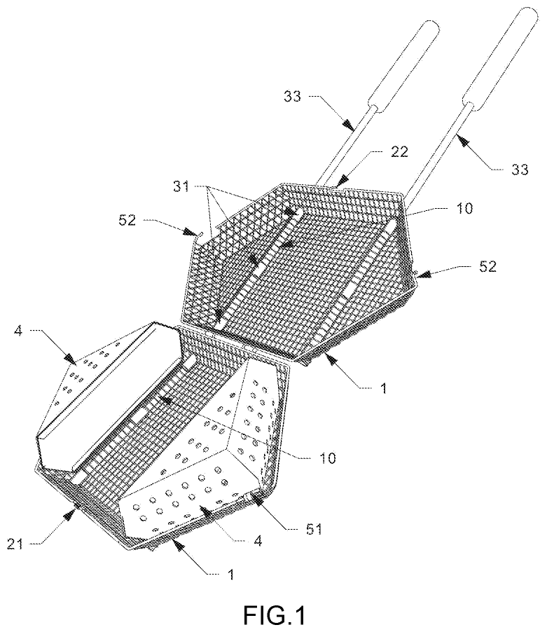

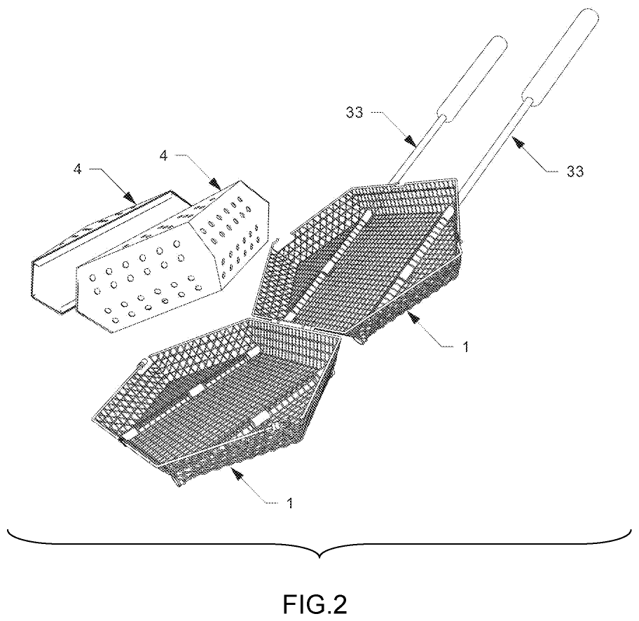

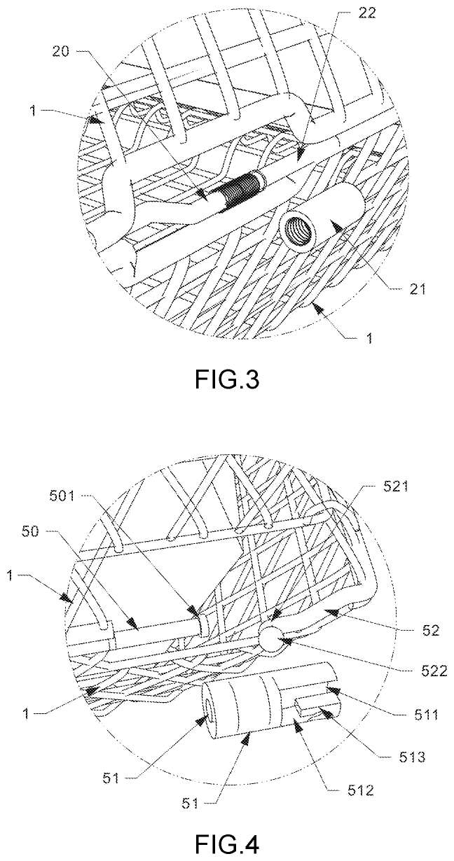

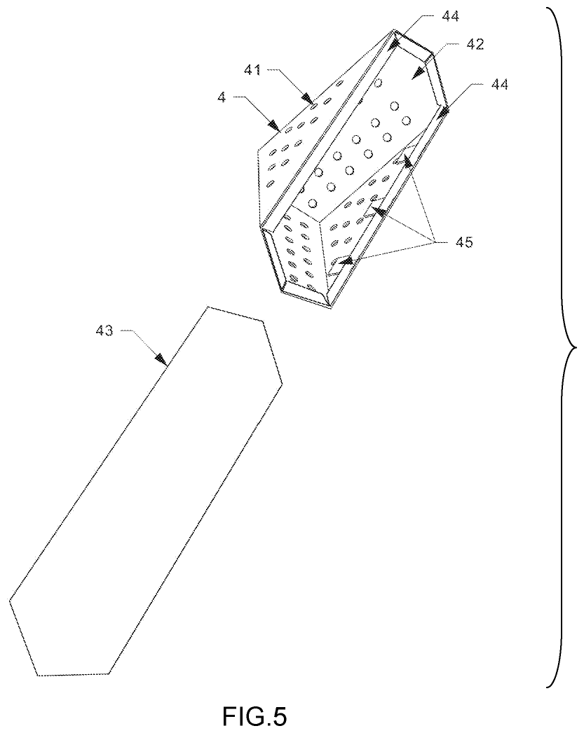

As shown in FIGS. 1 to 5, a multifunctional barbecue grill, wherein the barbecue grill is provided with two basket bodies 1 made of iron wire meshes, opening ends of the two basket bodies 1 are relatively fitted to each other at the top and the bottom, and the two basket bodies 1 are hinged to each other at the back edges of the opening ends;

a first lock catch 21 movably connected is provided at the front edge of an opening end of an upper basket body 1, and a first lock rod 22 for enabling the first lock catch 21 to be detachably connected is provided at the front edge of an opening end of a lower basket body 1;

a plurality of first sleeves 31 coaxially aligned from the front to the back are provided on the left side of the bottom surface of each basket body 1, a plurality of second sleeves 32 coaxially aligned from the front to the back are provided on the right side of the bottom surface of each basket body 1, and the first sleeves 31 and the second sleeves 32 are symmetrically provided with respect to the center line of the bottom surface of each basket body 1;

the barbecue grill is provided with two rod-shaped handles 33, one rod-shaped handle 33 penetrates the first sleeve 31 successively in a threaded manner, and the other rod-shaped handle 33 penetrates the second sleeve 32 successively in a threaded manner; an inward recessed clearance groove 10 is provided at the bottom surface of each basket body 1 so as to accommodate the rod-shaped handles 33; and

the barbecue grill is provided with two smoker boxes 4 separately made of metal plates, the smoker boxes 4 are respectively placed at the left and right ends inside the basket body 1, and the clearance groove 10 at the bottom surface of the basket body 1 abuts against one side of the smoker boxes 4 so as to face towards the middle of the basket body 1; a whole body of each smoker box 4 is provided with a plurality of small holes 41, one side of each smoker box is provided as an open end 42, and a removable cover plate 43 is mounted inside the open end 42.

In the described technical solution, the rod-shaped handle 33 of the multifunctional barbecue grill is detachable, and is more convenient to store and carry when being idle; during the barbecue process, when the barbecue grill does not need to be turned over and transferred, the rod-shaped handle 33 can be removed to avoid an excessively high temperature;

In the described technical solution, the basket bodies 1 of the multifunctional barbecue grill have reliable open and closed fitting structures, and when the barbecue grill is turned over, there will not have the accident of food scattering due to incorrect closing and unfirm closing; and

In the described technical solution, the multifunctional barbecue grill is provided with smoker boxer 4, and has cooking functions of barbecueing and smoking.

In a preferred technical solution, a first sleeve 31 is provided at each of the front end, the middle portion, and the back end on the left side of the bottom surface of each basket body 1, and a second sleeve 32 is provided at each of the front end, the middle portion, and the back end on the right side of the bottom surface of each basket body 1. The two rod-shaped handles 33 are connected to the same basket body 1 so that the user can operate the two rod-shaped handles simultaneously with both hands. In particular, as a first sleeve 31 is provided at each of the front end, the middle portion and the back end on the left side of the bottom surface of the basket body 1, and a second sleeve 32 is provided at each of the front end, the middle portion and the back end of the right side on the bottom surface of the basket body 1, two rod-shaped handles 33 can be additionally provided, so that two users can respectively load the rod-shaped handles 33 from the front side and the rear side of the basket body 1, thereby achieving the replacement operation for two persons.

In a preferred technical solution, a second lock catch 51 is provided on each of the left and right edges of the opening end of the lower basket body 1; and a second lock rod 52 for enabling the second lock catch 51 to be detachably connected is provided on each of the left and right edges of the opening end of the upper basket body 1. By means of the cooperation of the second lock catch 51 and the second lock rod 52, the left and right edges of the basket body 1 will not have the accident of food scattering due to incorrect closing and unfirm closing.

In a preferred technical solution, a rod-shaped joint 50 provided along the edge is provided on each of the left and right edges of the opening end of the lower basket body 1; the second lock catch 51 is columnar and is coaxially welded at the end of the rod-shaped joint 50; a notch 512 for enabling a side wall of the accommodation groove 511 to be opened is provided on a cylindrical surface of the second lock catch 51, and a barb 513 detouring inwards from the tail end of the second latch 51 to the notch 512 is provided on an edge of one side of the notch 512; in the upper basket body 1, the second lock rod 52 faces towards the accommodation groove 511 of the second lock 51 catch along the edge of the opening end of the basket body 1; a hook 521 which is bent towards the outside of the basket body 1 by ninety degrees is provided at the end of the second lock rod 52; a ball head 522 is provided at the end of the hook 521; the hook 521 is exactly hung in the barb 513 from the end of the second lock catch 51 by means of the notch 512; and the ball head 522 of the hook 521 abuts against the columnar surface of the second lock catch 51 by means of the barb 513, thereby achieving quick assembly and disassembly between the second lock catch 51 and the second lock rod 52.

In a preferred technical solution, a rod-shaped joint 50 provided along the edge is provided on each of the left and right edges of the opening end of the lower basket body 1; the second lock catch 51 is columnar, an inward recessed accommodation groove 511 is formed on an end surface of a tail end of the second lock catch 51, a notch 512 for enabling a side wall of the accommodation groove 511 to be opened is provided on a columnar surface of the second lock catch 51, and a barb 513 detouring inwards from the tail end of the second latch 51 to the notch 512 is provided on an edge of one side of the notch 512; a through hole 514 which is exactly fitted to the rod-shaped joint 50 in a sliding manner in an axial direction and is fitted to the rod-shaped joint 50 in a rotating manner in a circumferential direction is formed at the head end of the second lock catch 51, an end portion of the rod-shaped joint 50 enters the accommodation groove 511 from the through hole 514, and a stopper 501 having a diameter wider than the diameter of the through hole 514 is provided at the end portion of the rod-shaped joint 50; in the upper basket body 1, the second lock rod 52 faces towards the accommodation groove 511 of the second lock catch 51 along the edge of the opening end of the basket body 1; a hook 521 which is bent towards the outside of the basket body 1 by ninety degrees is provided at the end of the second lock rod 52; a ball head 522 is provided at the end of the hook 521; and the hook 521 exactly enters the notch 512 from the tail end of the second lock catch 51; and after the hook 521 enters the notch 512, the second lock catch 51 rotates to enable the hook 521 to hang in the barb 513, and the ball head 522 of the hook 521 is abutted against the columnar surface of the second lock catch 51 by means of the barb 513, thereby achieving the quick detachable fitting between the second lock catch 51 and the second lock rod 52.

In a preferred technical solution, a screw rod 20 provided along the edge is provided at a front edge of the opening end of the upper basket body 1, and a first lock catch 21 is in a cylindrical structure screwed to the tail end of the screw rod 20; in the upper basket body 1, the first lock rod 22 faces towards the cylindrical structure of the first lock catch 21 along the edge of the opening end of the basket body 1; when the first lock catch 21 is adjusted to be extended out of the bolt 20 by means of the screw thread, the end portion of the first lock rod 22 is sleeved in the cylindrical structure of the first lock catch 21, thereby achieving quick assembly and disassembly between the first lock catch 21 and the first lock rod 22.

In a preferred technical solution, a lip edge 44 formed by bending opposite to each other is provided at each of the upper and lower edges the open end 42 of each smoker box 4, the lip edge 44 is offset outwards relative to the end surface of the open end 42, and the cover plate 43 is inserted between the inner side of the lip edge 44 and the end surface of the open end 42 along the left or right edge of the open end 42, so that when the multifunctional barbecue grill of the present utility model is moved and turned over, there is no concern about the smoker box 4 sliding at will.

In a preferred technical solution, a bulge 45 fitted with a clearance between the lip edges 44 is formed at each of the top wall and the bottom wall of each smoker box 4, and the thickness of the cover plate 43 is set as an interference fit with respect to the fit clearance between the bulge 45 and the lip edges 44, thereby achieving a damping effect for the cover plate 43 inserted between the inner side of the lip edges 44 and the end surface of the open end 42, and being able to not be opened accidentally.

For a person skilled in the art, the scope of protection of the present utility model is not limited to the details of the above exemplary embodiments. Without departing from the spirit or essential features of the present utility model, all implementations of equivalent meanings made by a person skilled in the art on the basis of the requirements of the present utility model and all changes within the scope of protection should be encompassed in the present utility model.

What is claimed is:

1. A multifunctional barbecue grill,
wherein the barbecue grill is provided with two basket bodies made of iron wire meshes, opening ends of the two basket bodies are relatively fitted to each other at the top and the bottom, and the two basket bodies are hinged to each other at the back edges of the opening ends;
a first lock catch movably connected is provided at the front edge of an opening end of an upper basket body, and a first lock rod for enabling the first lock catch to be detachably connected is provided at the front edge of an opening end of a lower basket body;
a plurality of first sleeves coaxially aligned from the front to the back are provided on the left side of the bottom surface of each basket body, a plurality of second sleeves coaxially aligned from the front to the back are provided on the right side of the bottom surface of each basket body, and the first sleeves and the second sleeves are symmetrically provided with respect to the center line of the bottom surface of each basket body;
the barbecue grill is provided with two rod-shaped handles, one rod-shaped handle penetrates the first sleeve successively in a threaded manner, and the other rod-shaped handle penetrates the second sleeve successively in a threaded manner; an inward recessed clearance groove is provided at the bottom surface of each basket body so as to accommodate the rod-shaped handle handles; and
the barbecue grill is provided with two smoker boxes separately made of metal plates, the smoker boxes are respectively placed at the left and right ends inside the basket body, and the clearance groove at the bottom surface of the basket body abuts against one side of the smoker boxes so as to face towards the middle of the basket body; a whole body of each smoker box is provided with a plurality of small holes, one side of each smoker box is provided as an open end, and a removable cover plate is mounted inside the open end.

2. The multifunctional barbecue grill according to claim 1, wherein a first sleeve is provided at each of the front end, the middle portion, and the back end on the left side of the bottom surface of each basket body, and a second sleeve is provided at each of the front end, the middle portion, and the back end on the right side of the bottom surface of each basket body.

3. The multifunctional barbecue grill according to claim 1, wherein two rod-shaped handles are connected to the same basket body.

4. The multifunctional barbecue grill according to claim 1, wherein a second lock catch is provided on each of the left and right edges of the opening end of the lower basket body; and a second lock rod for enabling the second lock catch to be detachably connected is provided on each of the left and right edges of the opening end of the upper basket body.

5. The multifunctional barbecue grill according to claim 4, wherein a rod-shaped joint provided along the edge is provided on each of the left and right edges of the opening end of the lower basket body; the second lock catch is columnar and is coaxially welded at the end of the rod-shaped joint; an inward recessed accommodation groove is formed on an end surface of a tail end of the second lock catch, a notch for enabling a side wall of the accommodation groove to be opened is provided on a columnar surface of the second lock catch, and a barb detouring inwards from the tail end of the second latch to the notch is provided on an edge of one side of the notch; in the upper basket body, the second lock rod faces towards the accommodation groove of the second lock catch along the edge of the opening end of the basket body; a hook which is bent towards the outside of the basket body by ninety degrees is provided at the end of the second lock rod; a ball head is provided at the end of the hook; the hook is exactly hung in the barb from the end of the second lock catch by means of the notch; and the ball head of the hook abuts against the columnar surface of the second lock catch by means of the barb.

6. The multifunctional barbecue grill according to claim 4, wherein a rod-shaped joint provided along the edge is provided on each of the left and right edges of the opening end of the lower basket body; the second lock catch is columnar, an inward recessed accommodation groove is formed on an end surface of a tail end of the second lock catch, a notch for enabling a side wall of the accommodation groove to be opened is provided on a columnar surface, and a barb detouring inwards from the tail end of the second latch to the notch is provided on an edge of one side of the notch; a through hole which is exactly fitted to the rod-shaped joint in a sliding manner in an axial direction and is fitted to the rod-shaped joint in a rotating manner in a circumferential direction is formed at the head end of the second lock catch, an end portion of the rod-shaped joint enters the accommodation groove from the through hole, and a stopper having a diameter wider than the diameter of the through hole is provided at the end portion of the rod-shaped joint; in the upper basket body, the second lock rod faces towards the accommodation groove of the second lock catch along the edge of the opening end of the basket body; a hook which is bent towards the outside of the basket body by ninety degrees is provided at the end of the second lock rod; a ball head is provided at the end of the hook; and the hook exactly enters the notch from the tail end of the second lock catch; and after the hook enters the notch, the second lock catch rotates to enable the hook to hang in the barb, and the ball head of the hook is abutted against the columnar surface of the second lock catch by means of the barb.

7. The multifunctional barbecue grill according to claim 1, wherein a screw rod provided along the edge is provided at a front edge of the opening end of the upper basket body, and a first lock catch is in a cylindrical structure screwed to the tail end of the screw rod; in the upper basket body, the first lock rod faces towards the cylindrical structure of the first lock catch along the edge of the opening end of the basket body; when the first lock catch is adjusted to be extended out of the bolt by means of the screw thread, the end portion of the first lock rod is sleeved in the cylindrical structure of the first lock catch.

8. The multifunctional barbecue grill according to claim 1, wherein a lip edge formed by bending opposite to each other is provided at each of the upper and lower edges the open end of each smoker box, the lip edge is offset outwards relative to the end surface of the open end, and the cover plate is inserted between the inner side of the lip edge and the end surface of the open end along the left or right edge of the open end.

9. The multifunctional barbecue grill according to claim 8, wherein a bulge fitted with a clearance between the lip edges is formed at each of the top wall and the bottom wall of each smoker box, and the thickness of the cover plate is set as an interference fit with respect to the fit clearance between the bulge and the lip edges.
